(19) United States
(12) Patent Application Publication
(10) Pub. No.: US 2023/0412716 A1
(43) Pub. Date: Dec. 21, 2023

(54) CONVERTIBLE SMARTPHONE CASE APPARATUS

(71) Applicant: Anand Naishadh Mandaliya, Yorba Linda, CA (US)

(72) Inventor: Anand Naishadh Mandaliya, Yorba Linda, CA (US)

(21) Appl. No.: 18/185,618

(22) Filed: Mar. 17, 2023

Related U.S. Application Data
(60) Provisional application No. 63/366,432, filed on Jun. 15, 2022.

(51) Int. Cl. H04M 1/04

(52) U.S. Cl. CPC H04M 1/04

(57) ABSTRACT

A convertible smartphone case apparatus having a connector hinge; a first special-fitted smartphone case configured to be selectively engaged with connector hinge, wherein the first special-fitted smartphone case is configured to protect a first smartphone device; and a second special-fitted smartphone case configured to be selectively engaged with the connector hinge, wherein the second special-fitted smartphone case is configured to protect a second smartphone device; wherein each special-fitted smartphone case is configured to be selectively pivoted about the connector hinge. Each special-fitted smartphone case may be selectively pivoted about the connector hinge to assume a desired orientation. Each special-fitted smartphone case may be selectively detached from the connector hinge, while still protecting the corresponding smartphone device. Securing pegs attached to the connector hinge may be configured to engage with corresponding securing pockets nested within each special-fitted smartphone case to improve engagement between each special-fitted smartphone case and the connector hinge.

### CROSS-REFERENCE TO RELATED APPLICATIONS

This application claims the benefit of U.S. Provisional Application No. 63/366,432, filed Jun. 15, 2022, which is hereby incorporated by reference, to the extent that it is not conflicting with the present application.

### BACKGROUND OF INVENTION

### 1. Field of the Invention

The invention relates generally to smartphone device accessories, and specifically to smartphone cases configured to secure multiple smartphone devices.

### 2. Description of the Related Art

Some users of smartphones have the need to own more than one smartphone device. For example, a user may possess one smartphone for personal use and another for professional use. At times, this user may find it more convenient and practical to carry both smartphones with them (e.g., when in the workplace), while at other times find it more appropriate to bring only one smartphone along (e.g., on the weekend or weeknights). There are conventional multi-smartphone casing solutions for holding two smartphones together in a single unit that exist today, but they can be limiting in versatility, functionality, and continued protection in either a single or multi-smartphone use scenario.

More specifically, such existing conventional multi-smartphone casings (1) may serve merely as a carrying apparatus that restricts access to and utility of the smartphones when secured in such a conventional casing; (2) may require both smartphones to be of the same make and model (e.g., both smartphones be an iPhone 13 Pro®) or of a static make and model set (e.g., the conventional casing accommodates only a specific combination of smartphone models and the positioning of each smartphone is fixed to a specific side (i.e. the left or right side) of the conventional casing); (3) may not allow the two smartphones to be foldable in any or all practically desired directions (e.g., rotated inwards front-to-front, rotated outwards back-to-back, and opened flat top-to-top); (4) may restrict access to its camera features and/or sidewall buttons (e.g., volume up, volume down, silent mode, and/or lock screen) when folded, particularly in the inwards front-to-front position; and (5) may not allow for the simple and recurring separation of the two smartphones (such that each smartphone may operate independently of one another) without requiring the complete removal of such smartphone(s) from the conventional casing, which consequently increases the risk of damage to such smartphone(s) given the protective aspect of the conventional casing is no longer applicable.

Therefore, there is a need to solve the problems outlined above by providing a convertible smartphone case apparatus which is configured to easily and repeatedly attach and detach two smartphone cases, as desired, wherein each smartphone remains functional, accessible, and continuously protected in any configuration.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description.

In an aspect, a convertible smartphone case apparatus is provided, wherein the convertible smartphone case apparatus is comprised of three primary parts: (1) a connector hinge; (2) a first special-fitted smartphone case for a first smartphone device; and (3) a second special-fitted smartphone case for a second smartphone device, each further described below. For purposes of clarity, the first special-fitted smartphone case and second special-fitted smartphone case may be configured to secure and protect corresponding smartphone devices of the same or different makes and models. The connector hinge may be configured to be “a one-size-fits-all” connector element that is compatible with any special-fitted smartphone case that may be utilized within the convertible smartphone case apparatus. The connector hinge may be comprised of a first male connector end configured to engage with the first special-fitted smartphone case, a second male connector end configured to reversibly engage with the second special-fitted smartphone case, and an interconnection plate pivotally secured to the first and second male connector ends. Thus, an advantage is that each special-fitted phone case may be selectively pivoted about the connector hinge and selectively removed from the connector hinge, in turn providing enhanced functionalities as disclosed herein.

In another aspect, a convertible smartphone case apparatus may be provided wherein the convertible smartphone case apparatus is configured to enable the easy and repeatable action of attaching and detaching of each special-fitted smartphone case from the convertible smartphone case apparatus, accordingly, which in turn creates either a multi-case or single case scenario, as desired by the user. This is accomplished through the connection and disconnection of the connector hinge with each special-fitted smartphone case. Specifically, the attachment of the connector hinge with both special-fitted smartphone cases of the convertible smartphone case apparatus creates a multi-case smartphone use scenario, while the detachment of the connector hinge with both special-fitted smartphone cases creates a single smartphone use scenario.

In another aspect, a convertible smartphone case apparatus is provided, wherein said convertible smartphone case apparatus is configured to allow each smartphone to remain continuously protected from within its own special-fitted smartphone case, regardless of operating in a single or multi-smartphone use scenario. When in a single smartphone use scenario, the convertible smartphone case apparatus may be configured to provide the user with a similar experience to that of a standard, single smartphone case. This is accomplished by incorporating each special-fitted smartphone case with hinge receiver ports, which serve as the receptacle for the connector hinge to engage with. By embedding hinge receiver ports within each special-fitted smartphone case, a single smartphone use scenario can be achieved without the need to remove the smartphone device from its corresponding special-fitted smartphone case.

In another aspect, a convertible smartphone case apparatus is provided, wherein the convertible smartphone case allows for each secured smartphone to be fully rotated, relative to the other smartphone, thereby enabling the two smartphones to fold into any practically desired direction (e.g., rotated inwards front-to-front, outwards back-to-back, and opened flat top-to-top). This is accomplished by equipping the connector hinge with pin joints, which are configured to allow for complete 180-degree rotation of each of the two special-fitted smartphone cases and their corresponding smartphones about the connector hinge. In such embodiments, said convertible smartphone case apparatus can also achieve such rotation without obstructing access to any of the side buttons on either smartphone (e.g., volume up, volume down, silent mode, and/or lock screen). This is due to the purposeful positioning of the hinge receiver ports towards the bottom half of the special-fitted smartphone cases. Thus, an advantage is that the convertible smartphone case apparatus may be folded into a variety of positions or orientations without needing to reassemble the components of the convertible smartphone case apparatus.

In another aspect, a convertible smartphone case apparatus is provided, said convertible smartphone case apparatus being configured to allow the user to independently select the placement of each special-fitted smartphone case within the convertible smartphone case apparatus (e.g., the user can decide, and at any time alter, which smartphone is configured to be positioned on the left side and right side of the convertible smartphone case apparatus by selectively engaging the connector hinge with a corresponding side of each special-fitted smartphone case). This is accomplished by equipping each special-fitted smartphone case with two hinge receiver ports, with one hinge receiver port on each external facing side wall of its corresponding case wall. Thus, an advantage of this is that a variety of different configuration options may be made available to a user using the same components. In such embodiments, port fillers, as described further hereinbelow, may be configured to attach to any unused hinge receiver port, which in turn creates a smooth external-facing sidewall edges for such special-fitted smartphone case. An advantage of this is that users maintain optionality in orientation, while giving each special-fitted smartphone case a smooth and uniform outer surface.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIGS. 1A-1B illustrate front elevation view and rear elevation view, respectively, of a convertible smartphone case apparatus configured to secure two smartphone devices, according to an aspect.

FIG. 2A illustrates a front perspective view of a convertible smartphone case apparatus in an open, flat top-to-top orientation, according to an aspect.

FIG. 2B illustrates a front perspective view of convertible smartphone case apparatus in a closed, inward facing front-to-front orientation, according to an aspect.

FIGS. 3A-3B illustrate an exploded view and a front perspective view, respectively, of a connector hinge, according to an aspect.

FIG. 3C illustrates the front perspective view of an interconnection plate, according to an aspect.

FIGS. 4A-4D illustrate a front perspective view, top plan view, front elevation view and rear elevation view, respectively, of a male connector end of a connector hinge, according to an aspect.

FIGS. 5A-5B illustrate a top plan view and bottom plan view, respectively, of another embodiment of a convertible smartphone case apparatus in an open, flat top-to-top orientation, according to an aspect.

FIG. 6A illustrates a side perspective view of the convertible smartphone case apparatus folded in an outward back-to-back orientation, according to an aspect.

FIG. 6B illustrates a bottom perspective view of a convertible smartphone case apparatus in the process of being folded into an inwards, front-to-front orientation along a connector hinge, according to an aspect.

FIG. 6C illustrates a cross-sectional view of a connector hinge engaged with a first special-fitted smartphone case, according to an aspect.

FIGS. 7A-7D illustrate a front perspective view, top plan view, front elevation view and rear elevation view, respectively, of the port filler, according to an aspect.

FIG. 8A illustrates a side perspective view of convertible smartphone case apparatus having a port filler fully nested within a corresponding hinge receiver port of a special-fitted smartphone case, according to an aspect.

FIG. 8B illustrates a side perspective view of a convertible smartphone case apparatus whereby a port filler is in the process of engaging the corresponding hinge receiver port of a special-fitted smartphone case, according to an aspect.

FIG. 9A illustrates a front elevation view of a first special-fitted smartphone case and a second special-fitted smartphone case interconnected via a connector hinge, and therefore in a multi-case use configuration, according to an aspect.

FIG. 9B illustrates a front elevation view of a first special-fitted smartphone case and a second special-fitted smartphone case not attached to one another via a connector hinge, and therefore in single case use configuration, according to an aspect.

FIGS. 10A-10D illustrate the front elevation, left side elevation, rear elevation and right side elevation views, respectively, of a convertible smartphone case apparatus in an outward, back-to-back folded orientation, according to an aspect.

FIGS. 11A-11D illustrate the front elevation, left side elevation, rear elevation and right side elevation views, respectively, of a convertible smartphone case apparatus in a closed, inward front-to-front folded orientation, according to an aspect.

FIGS. 12A-12B illustrate front and rear perspective views, respectively, of a connector hinge, according to an aspect.

FIGS. 13A-13B illustrate the side perspective view and the enlarged side perspective view, respectively, of a hinge receiver port, according to an aspect.

FIG. 14 illustrates the side perspective view of a connector hinge in the process of engaging with the corresponding hinge receiver port a special-fitted smartphone case, according to an aspect.

FIG. 15 illustrates the front elevation view of a first special-fitted smartphone case and a second special-fitted smartphone case in a single case use configuration with all hinge receive ports connected with corresponding port fillers, according to an aspect.

FIG. 16 illustrates a front perspective view of a first special-fitted smartphone case configured for magnetic, wireless charging compatibility for its corresponding smartphone device, according to an aspect.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention.

It should be understood that, for clarity of the drawings and of the specification, some or all details about some structural components or steps that are known in the art are not shown or described if they are not necessary for the invention to be understood by one of ordinary skills in the art.

For the following description, it can be assumed that most correspondingly labeled elements across the figures (e.g., 101 and 201, etc.) possess the same characteristics and are subject to the same structure and function. If there is a difference between correspondingly labeled elements that is not pointed out, and this difference results in a non-corresponding structure or function of an element for a particular embodiment, example or aspect, then the conflicting description given for that particular embodiment, example or aspect shall govern.

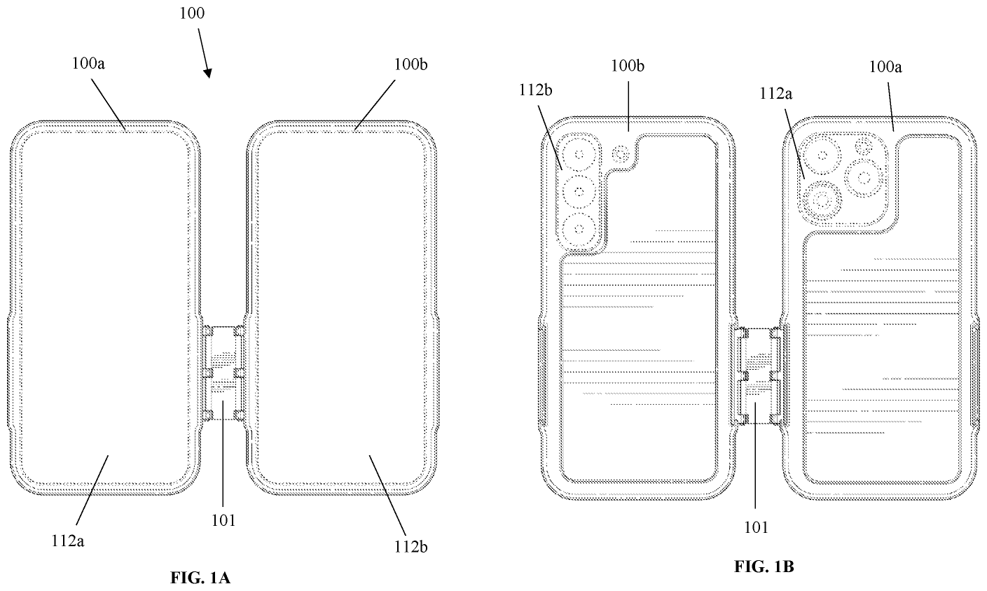

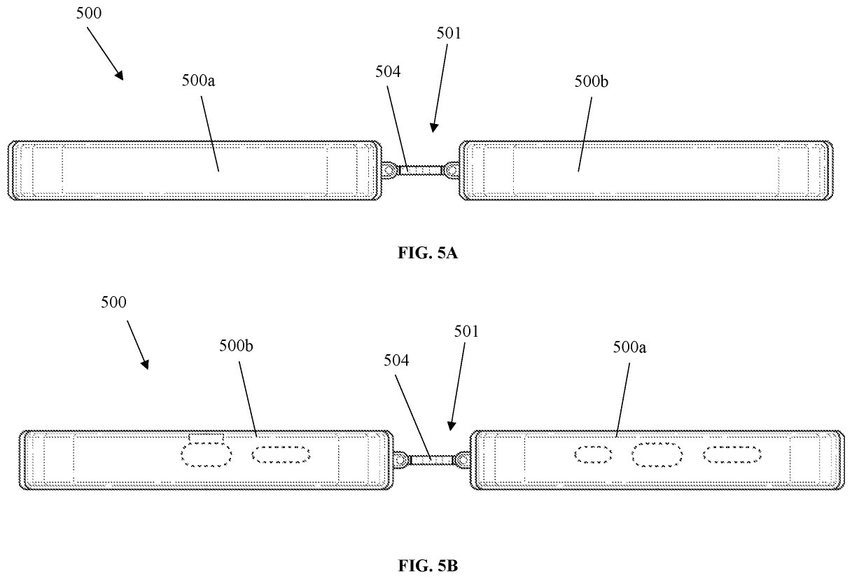

FIGS. 1A-1B illustrate front elevation view and rear elevation view, respectively, of a convertible smartphone case apparatus configured to secure two smartphone devices, according to an aspect. The convertible smartphone case apparatus 100 may be configured to secure two smartphone devices together in a singular, minimalist device case, regardless of the make or model of either smartphone device. In an embodiment, the convertible smartphone case apparatus 100 may be comprised of a first special-fitted smartphone case (“first smartphone case”) 100a, a second special-fitted smartphone case (“second smartphone case”) 100b and a connector hinge 101 configured to selectively secure the first special-fitted smartphone case 100a and the second special-fitted smartphone case 100b together. The connector hinge 101 may be configured to selectively engage with the first special-fitted smartphone case 100a and the second special-fitted smartphone case 100b, such that each special-fitted smartphone case 100a, 100b may be quickly and easily removed from the other special-fitted smartphone case 100b, 100a, respectively, based upon user preference. Furthermore, the connector hinge 101 may be configured to pivotally secure the first special-fitted smartphone case 100a and the second special-fitted smartphone case 100b together, such that each special-fitted smartphone case 100a, 100b of the convertible smartphone case apparatus 100 may be selectively pivoted about the connector hinge 101, or more specifically, a portion of the connector hinge 101, such as interconnection plate 504 of FIG. 5A, to assume several different orientations, as will be described in greater detail hereinbelow.

It should be understood that each special-fitted smartphone case 100a, 100b may be configured to secure a corresponding smartphone device 112a, 112b, respectively. In an embodiment, the first smartphone device 112a may be an iPhone 13 Pro® and the first special-fitted smartphone case 100a may be configured to securely engage with and protect such first smartphone device 112a. In the same embodiment, the second smartphone device 112b may be a Samsung Galaxy S22® and the second special-fitted smartphone case 100b may be configured to securely engage with and protect such second smartphone device 112b. It should be understood that the first special-fitted smartphone case 100a, and second special-fitted smartphone case 100b may both be configured to hold a desired make and model of smartphone, depending on the needs and preference of the user. In an alternative embodiment, both the first special-fitted smartphone case 100a and the second special-fitted smartphone case 100b may both be configured to engage with a smartphone device of the same make and model, such as an iPhone 13 Pro®. Either special-fitted smartphone case 100a, 100b of the convertible phone case apparatus 100 may be adapted to suitably engage with any desired make or model of phone, thus allowing the user to secure any two smartphone devices of any two makes or models together. The smartphone devices 112a, 112b may be omitted from the following embodiments to better display the aspects of the convertible smartphone case apparatus 100.

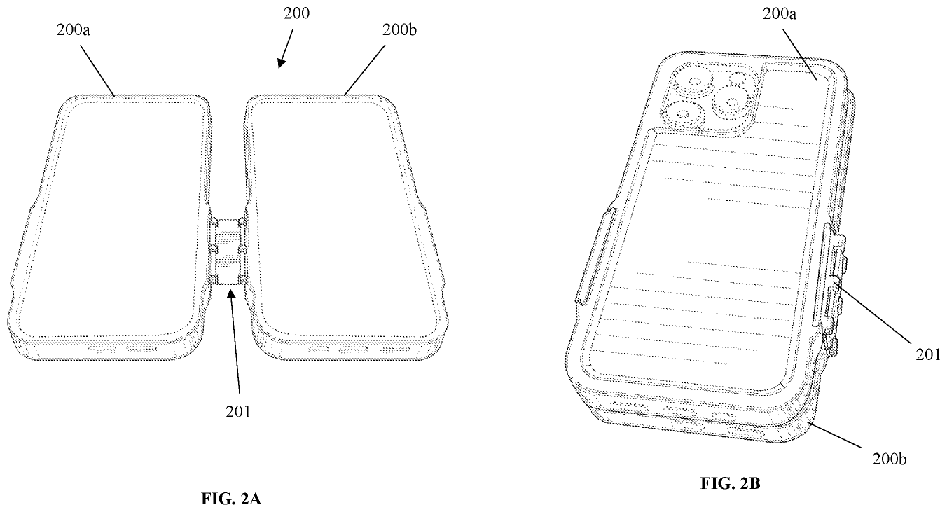

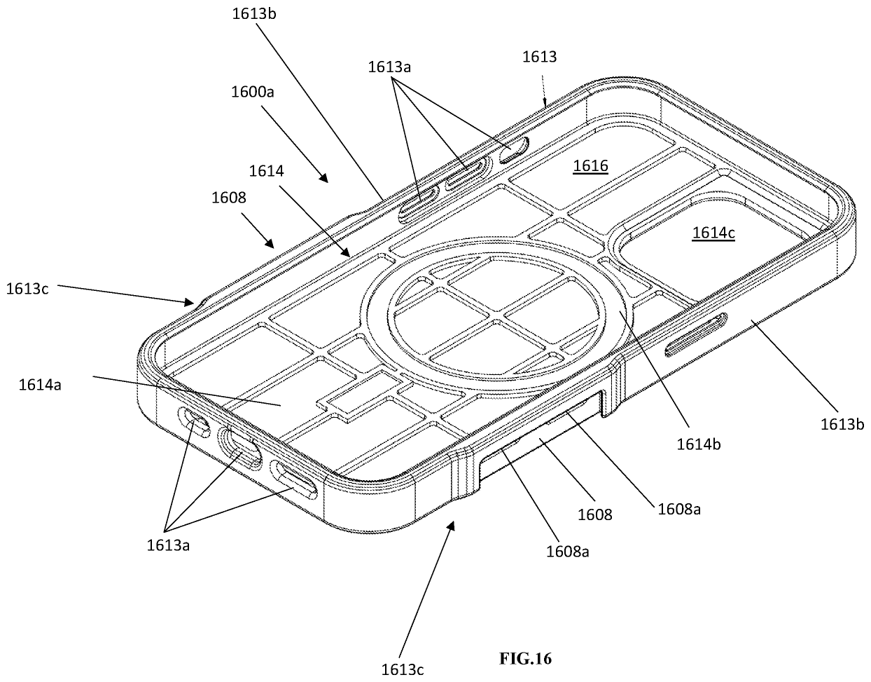

In the embodiment of FIG. 1A, the convertible smartphone case apparatus 100 may be folded into an open, flat top-to-top orientation in which screens of both smartphone devices 112a, 112b are facing in the same direction (e.g., out of the page, toward the user). This particular orientation may be referred to as a first position. In this first position, a user may access the screen portions of both smartphone devices 112a, 112b concurrently without needing to rotate or move the convertible phone case apparatus 100. Alternatively, as seen in FIG. 1B, the convertible smartphone case apparatus 100 may be rotated 180 degrees while in the first position, such that neither screen is accessible (e.g., both screens face into the page, away from the user). In this alternative first position, the rear-camera portions of both smartphone devices may be oriented toward a user holding the convertible smartphone case apparatus 100, which may be desirable for certain applications. The illustrative combination of special-fitted smartphone cases 100a, 100b configured to secure different makes and models may be used in the figures that follow, beginning with FIG. 2A and ending with FIG. 16.

By providing a convertible smartphone case apparatus 100 having two selectively separable special-fitted smartphone cases 100a, 100b, several advantages may be enjoyed. In an embodiment, a user may own a first smartphone device 112a for personal use and a second smartphone device 112b for professional use. The first special-fitted smartphone case 100a may be configured to secure and protect the first smartphone device 112a while the second special-fitted smartphone case 100b may be configured to secure and protect the second smartphone device 112b. While the user is in an environment in which having both of their smartphone devices 112a, 112b is necessary, such as in a work environment, the user may selectively engage both special-fitted smartphone cases 100a, 100b with the connector hinge 101, thus attaching both smartphone devices 112a, 112b together into a singular, minimalist structure that is easy to carry and allows selective usage of both smartphone devices 112a, 112b as needed.

In an alternative embodiment, while in an environment in which having only a singular phone is necessary or desirable, each special-fitted smartphone case 100a, 100b may be selectively removed from the connector hinge 101, enabling the user to carry only the preferred singular special-fitted smartphone case and corresponding smartphone device with them, such as the first special-fitted smartphone case 100a having the first smartphone device 112a. This will allow the user to carry a streamlined, singular special-fitted smartphone case with them, while leaving the other special-fitted smartphone case and smartphone device behind for later reattachment as necessary. In an example, during a weekend, a user may detach a second special-fitted smartphone case 100b carrying a second smartphone device 112b (used for work) from a first special-fitted smartphone case 100a carrying a first smartphone device 112a (utilized for personal use). This may allow a user to leave behind a work phone while not in use, thus reducing the number of smartphones they need to carry, while still providing protection for both smartphone devices 112a, 112b.

FIG. 2A illustrates a front perspective view of a convertible smartphone case apparatus 200 in an open, flat top-to-top orientation, according to an aspect. FIG. 2B illustrates a front perspective view of convertible smartphone case apparatus 200 in a closed, inward facing front-to-front orientation, according to an aspect. As disclosed hereinabove, the convertible smartphone case apparatus 200 may be configured to be rotated into multiple different orientations or positions. The open, flat top-to-top orientation may again be seen in FIG. 2A. In FIG. 2B, a second position, referred to as the closed, inward facing front-to-front orientation may be seen. This second position may be particularly useful for users who wish to protect both of their smartphone devices when not in active use. This orientation further reduces the overall size of the convertible smartphone case apparatus 200. In the second position, the screens of each smartphone, such as first smartphone device 112a and second smartphone device 112b of FIG. 1B, may be facing toward each other, and thus said screens may be concealed within the convertible smartphone case apparatus 200 and thus protected from external damaging structures.

This second position may be utilized by a user who wishes to store the convertible smartphone case apparatus 200 within their pocket or purse, while preventing damage to corresponding screen regions each smartphone. The transitioning between the first position and the second position may be done by selectively rotating the first special-fitted smartphone case 200a and the second special-fitted smartphone case 200b about their pivotal engagement with the connector hinge 201, as will be described in greater detail hereinbelow. As disclosed hereinabove, the first special-fitted smartphone case 200a and second special-fitted smartphone case 200b may each be configured to secure and protect a corresponding make and model of smartphone, such as an iPhone 13 Pro® and a Samsung Galaxy S22®, or any other known smartphone device.

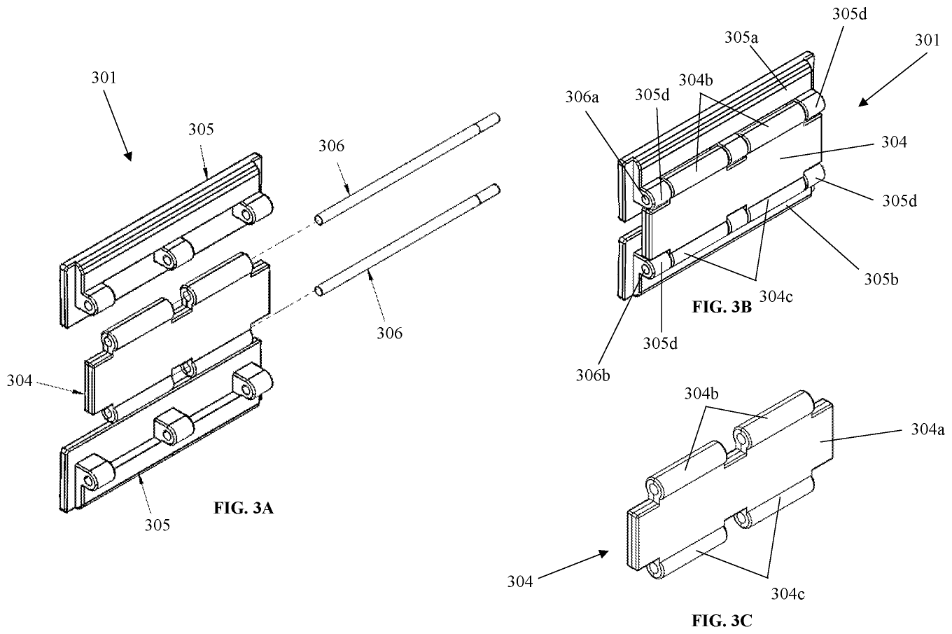

FIGS. 3A-3B illustrate an exploded view and a front perspective view, respectively, of a connector hinge 301, according to an aspect. As can be seen in the exploded view of the connector hinge 301, in an embodiment, the connector hinge 301 may be comprised of three sub-parts: (1) an interconnection plate 304, (2) two male connectors ends 305a, 305b and (3) pin joints 306a, 306b. In an embodiment, the interconnection plate 304 may be comprised of a firm, rigid material, such as a rigid plastic, wherein the interconnection plate 304 may be attached to a center, rotational axis of each male connector end 305 via a corresponding pin joint 306.

When fully constructed, the engagement of the pin joints 306 with each male connector end 305 enables rotation of the interconnection plate 304 around the male connector ends 305, which in turn allows for the full 180-degree rotation of the convertible smartphone case apparatus 300 in all practically desired directions (e.g., rotated closed inwards front-to-front, open outwards back-to-back, and open flat top-to-top). This arrangement of sub-parts further allows for rotation of each individual special-fitted smartphone case about the connector hinge 301 without having to rotate the other special-fitted smartphone case.

FIG. 3C illustrates the front perspective view of an interconnection plate 304, according to an aspect. It should be understood that the interconnection plate 304 may vary in width, which is intended to allow for the accommodation of any variation in smartphone size dimensions. These widths may be optimized as needed for different smartphones to be used with the convertible smartphone case apparatus and ensure proper fitting of each held smartphone in any closed or opened position. In an embodiment, the interconnection plate 304 may be comprised of an interconnection plate body 304a, a first pair of pin channels 304b nested within a first side of the interconnection plate body 304a, and a second pair of pin channels 304c nested within a second side of the interconnection plate body 304a. It should be understood that a first male connector end 305a may be configured to pivotally engage with the interconnection plate 304 by nesting a first pin joint 306a within a first pair of pin channels 304b nested within the interconnection plate 304 and corresponding plurality of connector end channels 305d nested within first male connector end 305a, wherein the first male connector end is configured to selectively engage with a first special-fitted smartphone case.

Similarly, the second male connector end 305b may be configured to pivotally engage with the interconnection plate 304 by nesting a second pin joint 306b within a second pair of pin channels 304c nested within the interconnection plate 304 and a corresponding plurality of connector end channels 305d nested within the second male connector end 305b, wherein the second male connector end is configured to selectively engage with a second special-fitted smartphone case, as will be described in greater detail hereinbelow. The quantity of connector end channels 305d nested within each corresponding male connector end 305a, 305b and the quantity of pin channels 304b, 304c nested within opposing ends of the interconnection plate 304 may be suitably adjusted depending on the needs of the convertible smartphone case apparatus, as long as rotational engagement between the interconnection plate 304 and the male connector ends 305a, 305b is maintained.

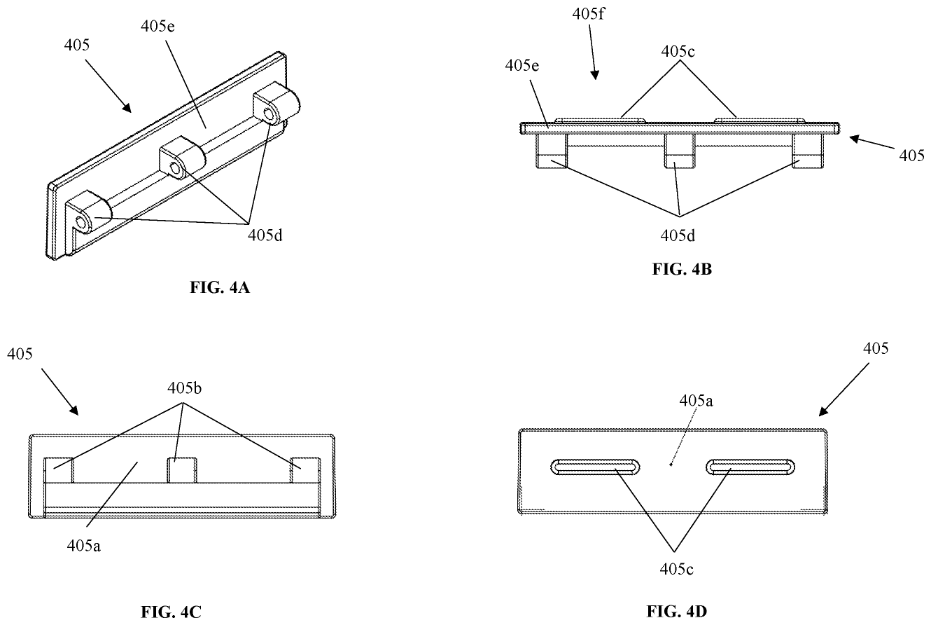

FIGS. 4A-4D illustrate a front perspective view, top plan view, front elevation view and rear elevation view, respectively, of a male connector end of a connector hinge, according to an aspect. In an embodiment, a male connector end 405 may be comprised of: (1) a connector end body 405e; (2) at least one connector end channel 405b nested within the connector end body 405e, wherein each connector end channel 405b is configured to receive a pin joint, such as pin joint 306 of FIG. 3A, to facilitate pivotal engagement with the interconnection plate; and (3) at least one securing peg 405c configured to further facilitate engagement with a corresponding special-fitted smartphone case. As disclosed hereinabove, each male connector end 405 may be pivotally engaged with the interconnection plate by nesting a corresponding pin joint within each connector end channel 405d of the male connector end 405 and corresponding pin channels nested within the interconnection plate. In alternative embodiments, more than three or fewer than three connector end channels 405d may be nested within the connector end body 405e, as long a secure, pivotal engagement between the male connector end 405a and the interconnection plate is established.

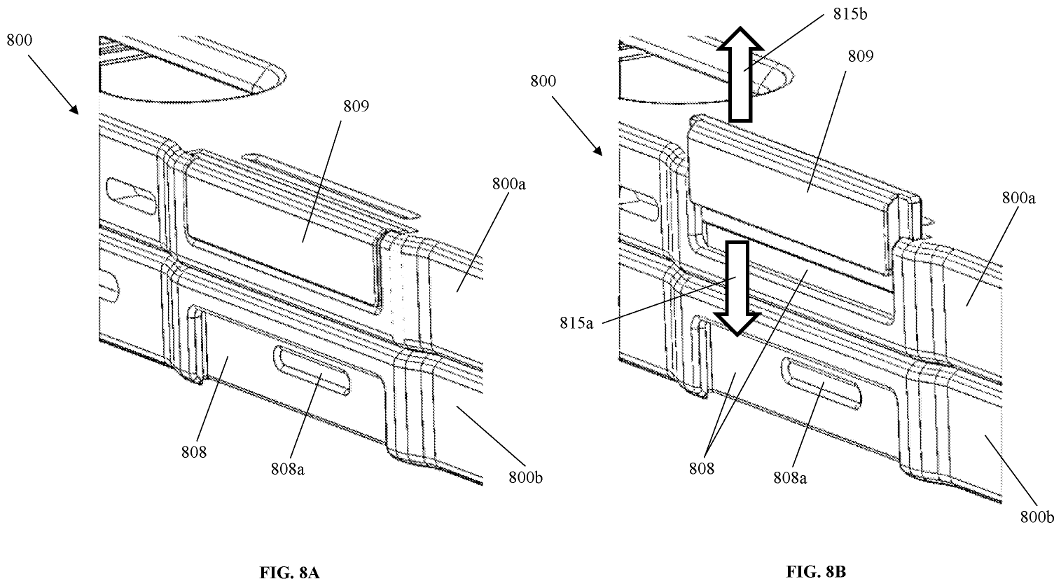

As can be seen in FIG. 4B and 4D, embodiments of the male connector end 405 may have two securing pegs 405c protruding from a corresponding case engaging surface 405f of the connector end body 405e. Each securing peg 405c may be configured to engage with a corresponding securing pocket, such as securing pocket 808a of FIG. 8A, as will be described in greater detail hereinbelow. It should be understood that the quantity of securing pegs disposed on the connector end body 405e, and the corresponding quantity of securing pockets nested within each special-fitted smartphone case may be suitably adjusted, depending on the needs of the application. The male connector ends 405 and their corresponding elements will be described in greater detail hereinbelow.

FIGS. 5A-5B illustrate a top plan view and bottom plan view, respectively, of another embodiment of a convertible smartphone case apparatus 500 in an open, flat top-to-top orientation, according to an aspect. For visual clarity, the connector hinge 501 shown in FIGS. 5A-5B is fully attached and engaged with each special-fitted smartphone case 500a, 500b of the convertible smartphone case apparatus. It should be understood that the male connector ends are both configured to be easily and repeatably attach and detach from their corresponding special-fitted smartphone case 500a, 500b of the convertible smartphone case apparatus 500 via a sliding feature or mechanism, as will be discussed in greater detail hereinbelow. It should be understood that the dimensions of the interconnection plate 504 of the connector hinge 501 may be suitably varied depending on the specifications of each special-fitted smartphone case 500a, 500b to ensure the that each special-fitted smartphone case 500a, 500b may be suitably rotated in the various configurations/positions disclosed herein. In an embodiment, the interconnection plate may be made of a rigid material, such as a hard plastic, to allow the connector hinge 501 to pivotally interconnect the two special-fitted smartphone cases 500a, 500b, while being configured to resist deformation and maintain the parallel orientation of the two special-fitted smartphone cases across the vertical y-axis. In other words, a first rotational axis of the first special-fitted smartphone case 500a may remain parallel with a second rotational axis of the second special-fitted smartphone case 500b upon engagement of each special-fitted smartphone case with the connector hinge 501, as will be described in greater detail hereinbelow.

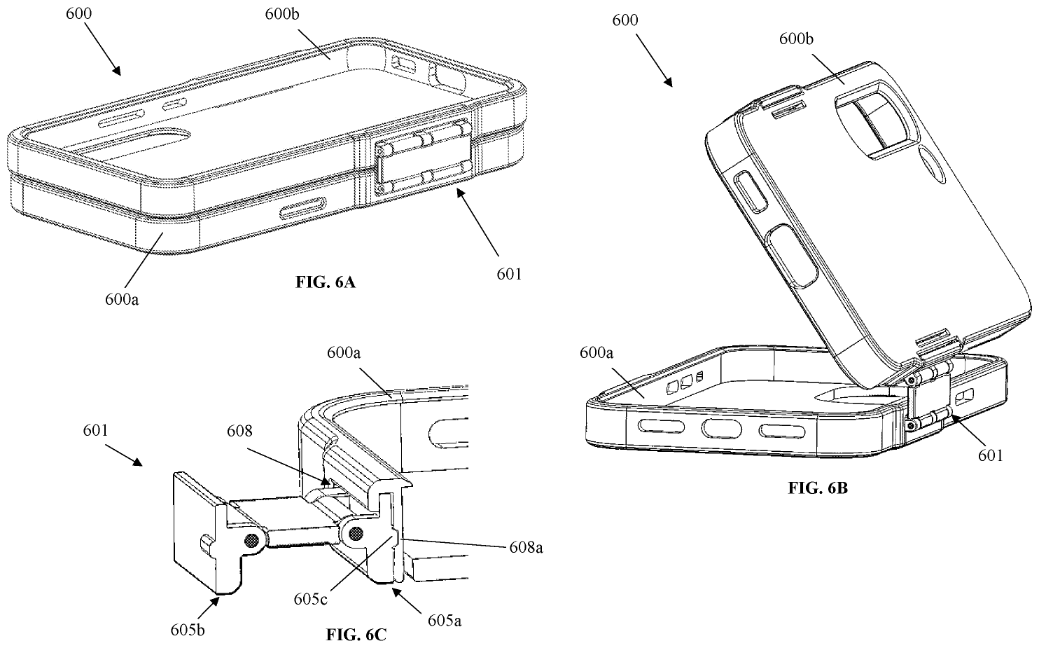

FIG. 6A illustrates a side perspective view of the convertible smartphone case apparatus 600 folded in an outward back-to-back orientation, according to an aspect. The convertible smartphone case apparatus 600 as shown in FIG. 6A in the outward back-to-back orientation may correspond to a third position of the convertible smartphone case apparatus 600. In this third position, a user may easily rotate the convertible smartphone case apparatus 600 a complete 180 degrees to access either screen of the smartphones quickly and easily, while allowing the convertible smartphone case apparatus 600 to assume a form that can be easily held in one hand. This configuration may be utilized by a user that intends to temporarily use one of their smartphones devices without needing to fully remove or detach such device and/or special-fitted smartphone case from the convertible smartphone case apparatus 600. FIG. 6B illustrates a bottom perspective view of a convertible smartphone case 600 in the process of being folded into an inwards, front-to-front orientation along a connector hinge, according to an aspect. FIG. 6C illustrates a cross-sectional view of a connector hinge 601 engaged with the hinge receiver port 608 of a first special-fitted smartphone case 600a, according to an aspect.

As can be seen in FIG. 6C, a first male connector end 605a of a connector hinge 601 may be configured to engage with a corresponding hinge receiver port 608 nested within a first special-fitted smartphone case 600a. This engagement may entail the nesting of the corresponding first male connector end 605 within a corresponding hinge receiver port 608 of a first special-fitted smartphone case 600a, such that each corresponding securing peg 605c disposed on the first male connector end 605a is configured to engage with and be nested within a corresponding securing pocket 608a nested within a hinge receiver port 608 of the first special-fitted smartphone case 600a. This selective engagement between the first male connector end 605a and the hinge receiver port 608 may allow the first special-fitted smartphone case 600a to be removed and/or attached to the convertible phone case apparatus 600, and thus the second special-fitted smartphone case 600b, at will. It should be understood the second male connector end 605b may be configured to selectively engage with the second special-fitted smartphone case 600b in a manner similar or the same as the engagement between the first male connector end 605a and the first special-fitted smartphone case 600a as described hereinabove.

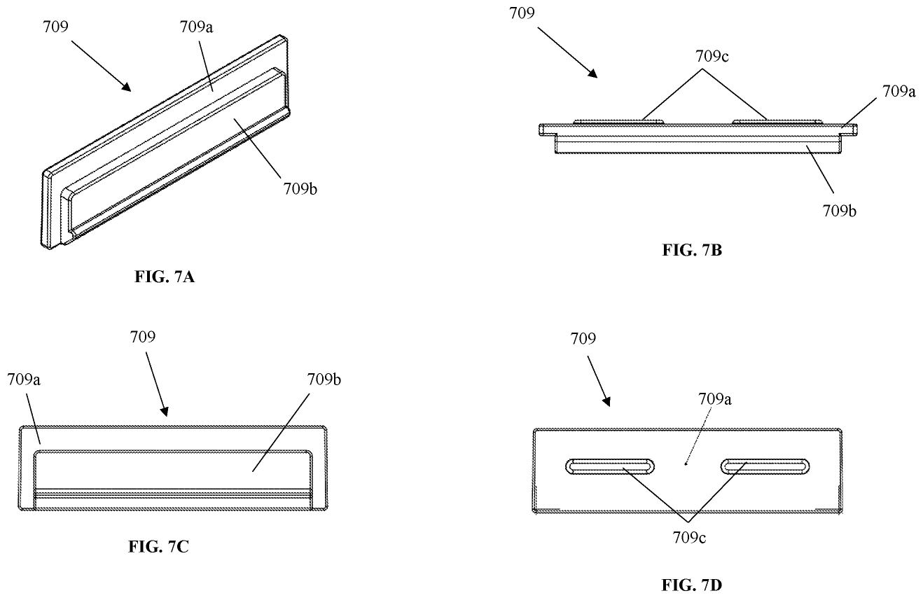

FIGS. 7A-7D illustrate a front perspective view, top plan view, front elevation view and rear elevation view, respectively, of the port filler 709 having a rib feature 709b, according to an aspect. In an embodiment, a port filler 709 may be comprised of: (1) a port filler body 709a; (2) a rib feature 709b attached to the port filler body 709a, wherein the rib feature 709b is configured to be manipulated to facilitate selective removal of the port filler 709 from a corresponding hinge receiver port, such as hinge receiver port 608 of FIG, 6C; and (3) a least one securing peg 709c attached to the port filler body 709a. The securing peg(s) 709c disposed on the port filler 709 may be identical (or comparable) in size, quantity and positioning to the securing pegs disposed on each male connector end body, such as securing pegs 405c disposed on male connector end 405 of FIG. 4D, such that each hinge receiver port on each special-fitted smartphone case is configured to selectively receive either a male connector end or a port filler 709, accordingly. In an embodiment, the size and shape of the port filler body 709a may be roughly the same as the male connector ends, except for the exclusion of the connector end channels in the prior. It should be understood that each port filler body 709a and connector end body may be configured to follow the contours of the surround case wall portion that it is nested within, as seen in FIG. 8A and 6A respectively.

By allowing each hinge receiver port that is not engaged with a male connector end to instead engage with a port filler 709, a smooth external-facing sidewall edge for such special-fitted smartphone case has now been created. As such, each port filler 709 may be configured to cover an unoccupied hinge receiver port (e.g., a hinge receiver port not directly engaged with a connector hinge). Furthermore, the shape and size of the rib feature 709b may be suitably adjusted to establish a protrusion from the port filler 709 that is sufficiently easy to grip and engage with while not being overly bulky or protruding excessively far from each smartphone case edge. The disclosed port filler embodiment of FIG. 7B, 7D may have two securing pegs 709c, but it should be understood that alternative embodiments may utilize fewer or additional securing pegs 709c depending on the needs of the application, presence of fewer or additional securing pockets within each hinge receiver port, etc. The rib feature 709b may be omitted from certain embodiments of the port filler 709, as disclosed hereinbelow, as long as a user may still remove the port filler 709 from a corresponding hinge receiver port without undue effort. It should be understood that the convertible smartphone case apparatus may be configured such that port fillers 709 and male connector ends may be configured to engage with any special-fitted smartphone case, regardless of the make or model of the smartphone device for which said special-fitted smartphone case was designed to hold.

FIG. 8A illustrates a side perspective view of convertible smartphone case apparatus 800 having a port filler 809 fully nested within a corresponding hinge receiver port 808, according to an aspect. FIG. 8B illustrates a side perspective view of a convertible smartphone case 800 having a port filler 809 in the process of engaging with a corresponding hinge receiver port 808, according to an aspect. In FIG. 8A-8B, the convertible smartphone case apparatus 800 may be shown in the second position, as described hereinabove, wherein the convertible smartphone case apparatus 800 is folded in an inward, front-to-front orientation, such that corresponding hinge receiver ports 808 of the first special-fitted smartphone case 800a and the second special-fitted smartphone case 800b that are not connected by a connector hinge are also adjacent to each other. The disclosed port filler 809 may be configured to engage with a corresponding hinge receiver port 808 via a sliding feature, whereby the port filler 809 is configured to be slid in a first direction 815a into the corresponding receiver port 808 to facilitate engagement between the port filler 809 and the corresponding special-fitted smartphone case 800a. Furthermore, the port filler 809 may be selectively disengaged from the corresponding special-fitted smartphone case 800a by sliding the port filler 809 in a second direction 815b, opposite the first direction 815a, such that the port filler 809 is slid out of the corresponding receiver port 808. This same sliding mechanism may be utilized to engage a male connector end with a corresponding hinge receiver port, as needed.

It should be understood that each special-fitted smartphone case 800a, 800b of the convertible smartphone case apparatus 800 may have two hinge receiver ports 808, with one hinge receiver port disposed on each external-facing side wall, such as external facing side walls 1613b of FIG. 16. These hinge receiver ports 808 may be carved-out grooves within the external-facing side walls, which serve as the receptacles for either the male connector ends of a connector hinge, such as male connector end 305 of FIG. 3A, or a port filler 809, as decided by the individual user. The port filler 809 may serve as the cover of any hinge receiver port 808 that is not engaged with a connector hinge. Once inserted and secured, a port filler 809 may be configured to create a leveled, flush external-facing side wall of the special-fitted smartphone case.

For clarity, a hinge receiver port may be configured to engage with either (1) a port filler 809 or (2) the male connector end of a connector hinge. Both the port fillers 809 and male connector ends may have a long, thin rectangular plate which can each be slid in and out of one of the hinge receiver ports 808, each as desired. For purposes of further clarity, the sliding feature configurations, that is to say, the mechanisms utilized to slidably engage a corresponding element with a hinge receiver port 808, may be congruent across all port fillers 809 and male connector ends, whereby both are equally compatible with any hinge receiver ports found on any special-fitted smartphone case 800a, 800b, regardless of the underlying smartphone device make or model configured to be held in each special-fitted smartphone case 800a, 800b. As disclosed hereinabove, each hinge receiver port 808 may have one or more securing pocket(s) 808a that are configured to engage with the securing pegs of either a port filler 809 or a male connector end to improve engagement between the special-fitted smartphone case 808a, 808b and a corresponding port filler 809 or connector hinge across all embodiments of the convertible smartphone.

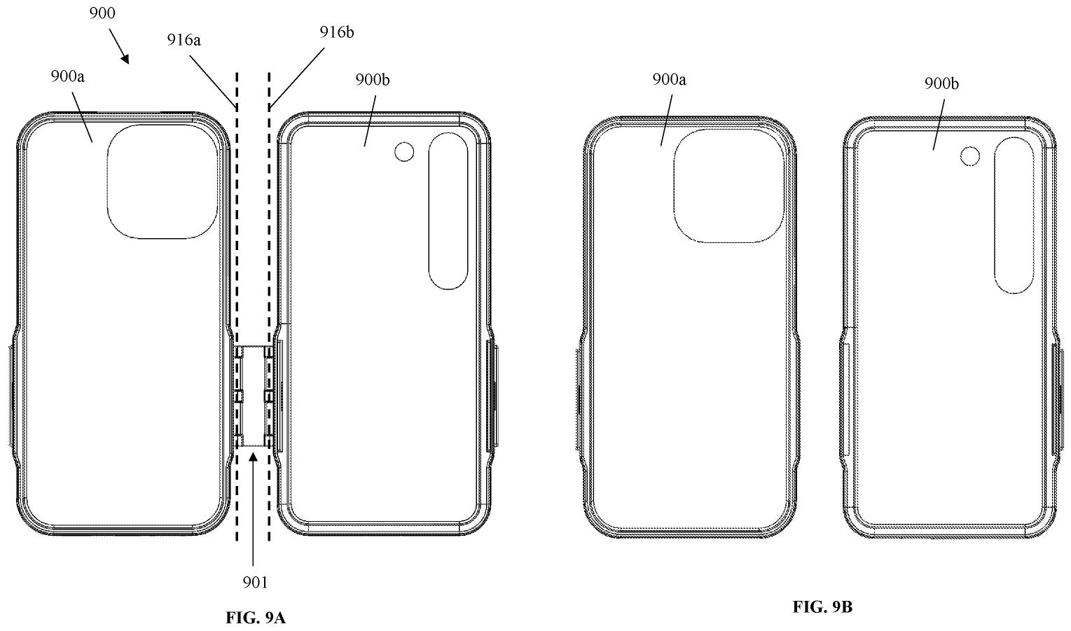

FIG. 9A illustrates front elevation view of a first special-fitted smartphone case 900a and a second special-fitted smartphone case 900b interconnected via a connector hinge 901, and therefore in a multi-case use configuration, according to an aspect. FIG. 9B illustrates a front elevation view of a first special-fitted smartphone case 900a and a second special-fitted smartphone case 900b not connected via a connector hinge, and therefore in a single case use configuration, according to an aspect. In an exemplary embodiment, the first special-fitted smartphone case 900a may be configured to hold an iPhone 13 Pro® and the second special-fitted smartphone case 900b may be configured to hold a Samsung Galaxy S22®. As disclosed hereinabove, the first special-fitted smartphone case 900a and the second special-fitted smartphone case 900b may be attached together by a connector hinge 901 which has been slid in and attached to the corresponding hinge receiver ports of each special-fitted smartphone case 900a, 900b. As can be seen in FIG. 9B, in the absence of a connector hinge 901, these two special-fitted smartphone cases 900a, 900b may be carried and utilized independently of each other, while maintaining the protection of each smartphone device by its individual special-fitted smartphone case 900a, 900b. This allows for each smartphone to remain protected regardless of whether the convertible smartphone case apparatus 900 is configured in a single or multi-smartphone use scenario. As disclosed hereinabove, while each special-fitted smartphone case 900a, 900b is interconnected by the connector hinge 901, the convertible smartphone case apparatus 900 may assume an outward back-to-back orientation (third position as seen in FIG. 6A), an inward facing front-to-front position (second position as seen in FIG. 2B) or any orientation in between, depending on the preference of the user.

As described hereinabove, the connector hinge 901 may be comprised of sufficiently rigid materials(s) to maintain the parallel orientation of the two special-fitted smartphone cases 900a, 900b across the vertical y-axis. As such, the first special-fitted smartphone case 900a may be configured to be pivoted about a first rotational axis 916a, whereas the second special-fitted smartphone case 900b may be configured to be pivoted about a second rotational axis 916b, wherein the first rotational 916a axis is configured to remain parallel with the second rotational axis 916b, as can be seen in FIG. 9A, regardless of the convertible smartphone case apparatus orientation. By maintaining the parallel disposition between the first and second rotational axis 916a, 916b while the first and second special-fitted smartphone cases 900a, 900b are engaged with the connector hinge 901, each special-fitted smartphone case 900a, 900b, may be allowed to lay flush against the other special-fitted smartphone case 900b, 900a upon being rotated to an operational extreme (e.g., the second position and third position, as seen in FIG. 2B and 6A, respectively). As a result of the first rotational axis 916a of the first special-fitted smartphone case 900a being configured to remain parallel with the second rotational axis 916b of the second special-fitted smartphone case 900b, a sturdy case assembly may be provided that does not warp or bend unexpectedly.

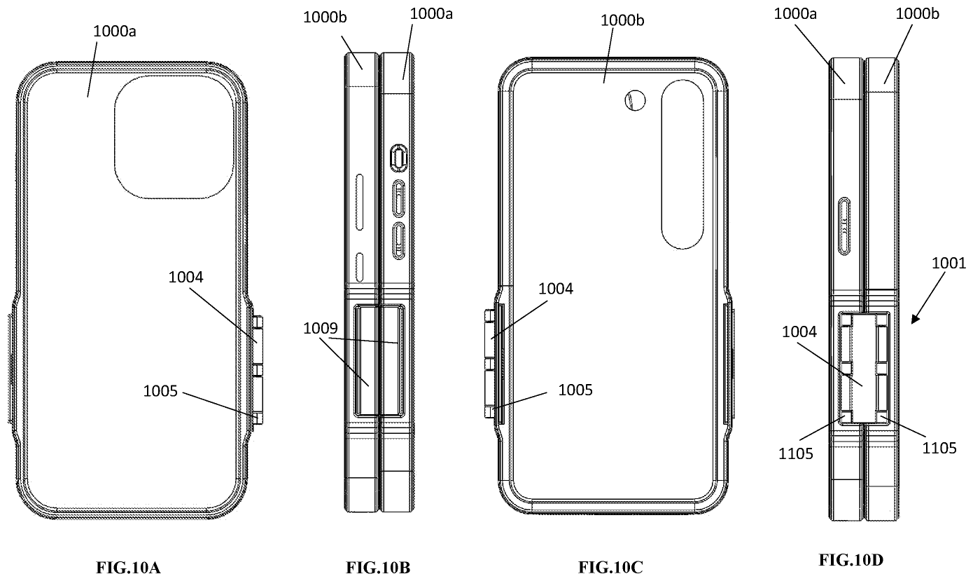

FIGS. 10A-10D illustrate the front elevation, left side elevation, rear elevation and right side elevation views, respectively, of a convertible smartphone case apparatus 1000 oriented in an outward, back-to-back folded orientation, according to an aspect. As can be seen in FIGS. 10A-10B, as the two special-fitted smartphone cases 1000a and 1000b may be oriented outwards, back-to-back orientation, analogous to what is as seen in FIG. 6A, wherein the screens of both smartphones held within the convertible smartphone case apparatus 1000 will be available for use when the convertible smartphone case apparatus 1000 is in such an open, outward position (e.g., third position). In this configuration, the connector hinge 1001 and its corresponding interconnection plate 1004 and male connector ends 1005 may be disposed on the right-hand side of the convertible smartphone case apparatus 1000 when the first special-fitted smartphone case 1000a is on top of the second special-fitted smartphone case 1000b. As described hereinabove, any hinge connector ports that are not being actively engaged with a connector hinge 1001 may instead be engaged with and covered by a port filler 1009 to maintain a smooth, uniform case structure and appearance.

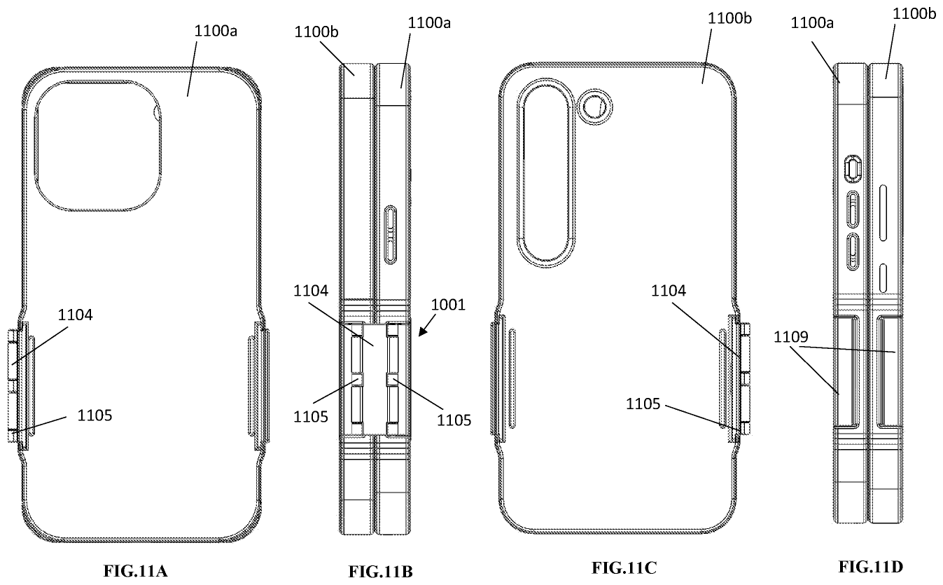

FIGS. 11A-11D illustrate the front elevation, left side elevation, rear elevation and right side elevation views, respectively, of a convertible smartphone case apparatus 1100 oriented in a closed, inward front-to-front folded orientation, according to an aspect. In this alternative orientation (e.g., second position) of the same convertible smartphone case apparatus 1100, the two special-fitted smartphone cases 1100a and 1100b may be oriented such that smartphones held within each special-fitted smartphone case 1100a, 1100b would be folded closed screen-to-screen (i.e., inward front-to-front) when the convertible smartphone case apparatus 1100 is in a closed orientation. In this embodiment, the screens of both smartphones may not be exposed to the external environment, thus providing an additional layer of protection for both smartphones, while still allowing the convertible smartphone case apparatus 1100 to be unfolded and allow both smartphones to be used if needed. In this configuration, the connector hinge 1101, and its associated male connector ends 1105 and interconnection plate 1104 may be disposed on the left-hand side of the convertible smartphone case apparatus 1100 when the first special-fitted smartphone case 1100a is positioned on top of the second special-fitted smart phone case 1100b. As described hereinabove, unused hinge connector ports may be covered with port fillers 1109 to create smooth edges on the outside walls of the convertible smartphone case apparatus.

It should be understood that the two configuration examples illustrated by FIGS. 10A-10D and FIGS. 11A-11D may have the same interconnections between elements (e.g., as can be seen by FIG. 10D and FIG. 11B, the connector hinge 1001 and 1101 remains disposed on the same physical ends of both special-fitted smartphone cases) and thus are simply showing different orientations of the same convertible smartphone case apparatus 1000, 1100 arrangement. In other words, by folding the convertible smartphone case apparatus 1100 in one extreme direction, a closed, inward screen-to-screen configuration may be achieved, while folding the convertible smartphone case apparatus 1000 in the opposite extreme direction, an open outward, back-to-back configuration may be achieved. Therefore, both configurations disclosed above may be achieved without removing and reattaching components, by simply rotating each special-fitted smartphone case about its corresponding connector hinge accordingly.

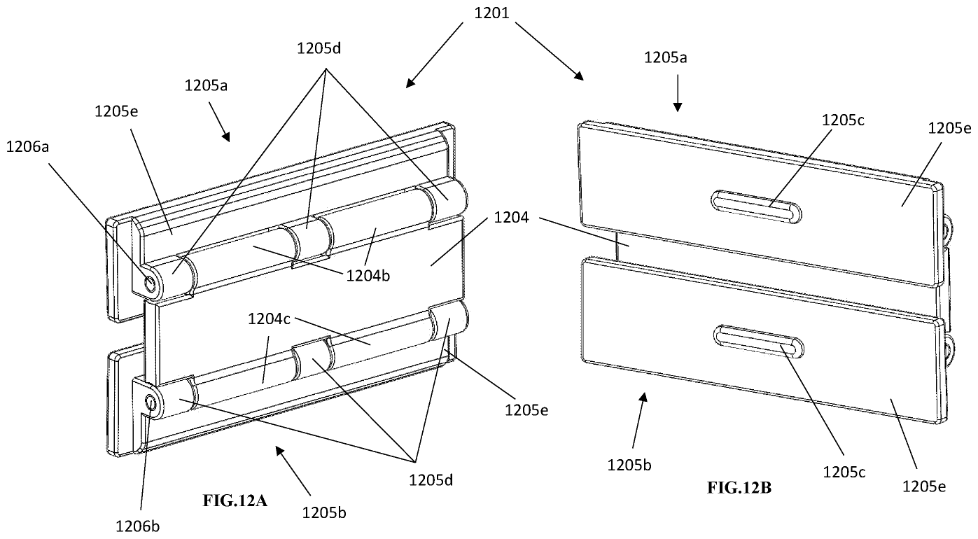

FIGS. 12A-12B illustrate front and rear perspective views, respectively, of a connector hinge, according to an aspect. As described hereinabove, the connector hinge 1201 may be comprised of three sub-parts: (1) an interconnection plate 1204; (2) two male connector ends: a first male connector end 1205a and a second male connector end 1205b; and (3) a set of pin joint: a first pin joint 1206a and a second pin joint 1206b. The two male connector ends 1205a and 1205b may be attached to opposite ends of a centrally disposed interconnection plate 1204 via a set of rotating pin joints 1206a and 1206b, such that each male connector end 1205a, 1205b may be configured to rotate a full 180-degrees about the interconnection plate 1204. Each male connector end 1205a, 1205b may be configured such that a corresponding special-fitted smartphone case secured to each male connector end 1205a, 1205b may also be rotated such that the convertible smartphone case apparatus can be folded in any practically desired position (e.g., rotated inwards front-to-front, outwards back-to-back, and flat top-to-top, etc.).

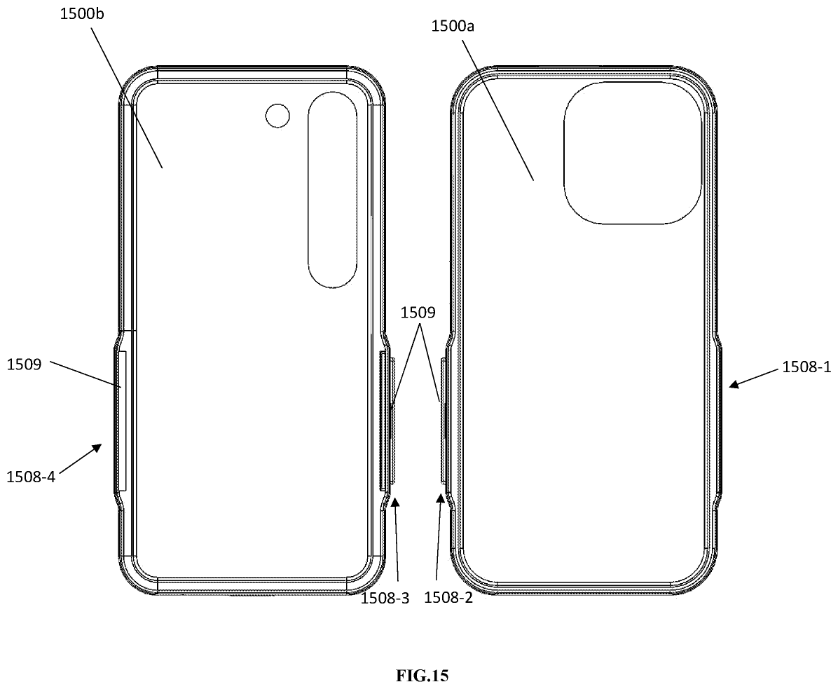

In an embodiment, one male connector end, such as the first male connector end 1205a in FIG. 12A, can slide into, and thereby engage the connector hinge with, a corresponding hinge receiver port of a first special-fitted smartphone case, such as the hinge receiver port 1508-2 of FIG. 15, while the other male connector end 1205b in FIG. 12A slides into a corresponding hinge receiver port of the second special-fitted smartphone case, such as the hinge receiver port 1508-3 of FIG. 15. The male connector ends 1205a, 1205b of the connector hinge 1201 and the hinge receiver ports are described herein as critical components which connect the two special-fitted smartphone cases together, therefore creating the multi-case use scenario of the convertible smartphone case apparatus. At any time, either of the special-fitted smartphone cases can be selectively detached from the connector hinge 1201 to enable the user to operate in a single case use scenario as needed, while preserving each smartphone in its own protective special-fitted smartphone case.

Each male connector end 1205a and 1205b may be further comprised of securing pegs 1205c disposed on the corresponding connector end body 1205e, wherein said securing pegs 1205c are configured to engage with complementary structural elements within the corresponding hinge receiver port (i.e., securing pockets). In an embodiment, a first pair of pin channels 1204b nested within the interconnection plate 1204 may be configured to coaxially align with a plurality of connector end channels 1205d nested within the first male connector end 1205a, such that a first pin joint 1206a may be nested within the coaxially aligned first pair of pin channels 1204b and the plurality of connector end channels 1205d nested within the first male connector end 1205a to facilitate pivotal and rotational engagement between the interconnection plate 1204 and the first male connector end 1205a. Similarly, in said embodiment, a second pair of pin channels 1204c nested within the interconnection plate 1204 may be configured to coaxially align with a plurality of connector end channels 1205d nested within the second male connector end 1205b, such that a second pin joint 1206b may be nested within the coaxially aligned second pair of pin channels 1204c and the plurality of connector end channels 1205d nested within the second male connector end to facilitate pivotal and rotational engagement between the interconnection plate 1204 and the second male connector end 1205b. As such, each special-fitted smartphone case engaged with a male connector end 1205a, 1205b may thusly also be allowed to selectively rotate about the interconnection plate 1204. While each disclosed male connector end 1205a, 1205b of FIG. 12B may be shown to only have a singular securing peg 1205c, this may be adjusted or modified accordingly, depending on the needs of the corresponding convertible smartphone case apparatus.

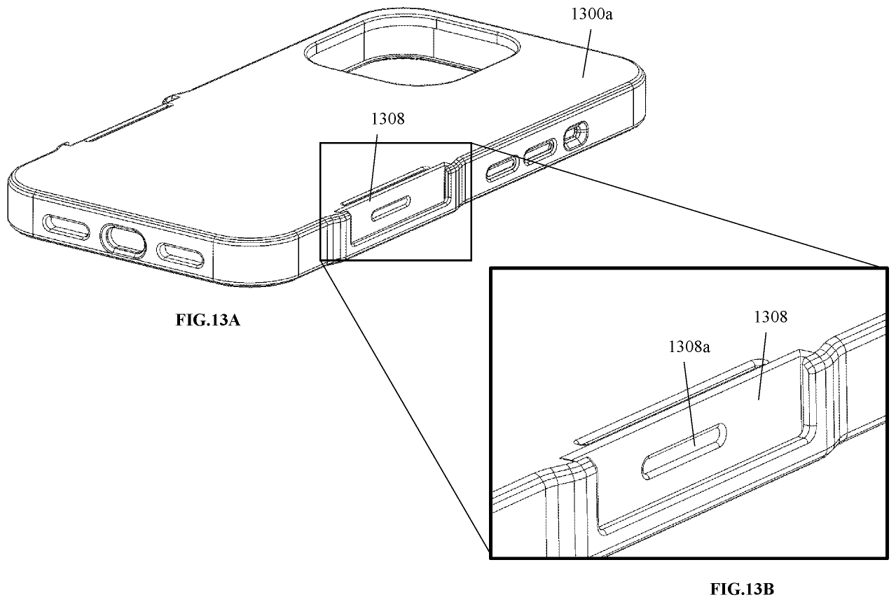

In an embodiment, an additional securing peg 1205c may be attached to each male connector end 1205a, 1205b, such that the connector hinge embodiment 1201 of FIG. 12A-12B may be modified into the connector hinge embodiment 301 of FIG. 3A-3B. It should be understood that an additional securing pocket, such as securing pocket 1308a of FIG. 13, may be nested within a corresponding hinge receiver port, such that the hinge receiver port embodiment 1308 of FIG. 13 may be modified into the hinge receiver port embodiment 1608 of FIG. 16. In order to ensure secure engagement between a hinge receiver port and a corresponding male connector end 1205a, 1205b or a port filler, the quantity, positioning, size, etc., of securing pegs on each corresponding element may be complementary with the quantity, positioning, size, etc., of the securing pockets in each hinge receiver port.

FIGS. 13A-13B illustrate the side perspective view and the enlarged side perspective view, respectively, of a hinge receiver port 1308, according to an aspect. A securing pocket 1308a may be nested within each hinge receiver port 1308 of a special-fitted smartphone case 1300a, in order to enable a more secure engagement of the special-fitted smartphone cases to the connector hinge or port filler. As described hereinabove, each special-fitted smartphone case may have two hinge receiver ports 1308, whereby each hinge receiver port 1308 is embedded within the external-facing side walls of said special-fitted smartphone case, such as external facing side walls 1613b of FIG. 16. This allows for the user to decide which special-fitted smartphone case (and thus which smartphone) is attached on the left and right side of the convertible smartphone case apparatus. As also described hereinabove, the quantity, positioning and orientation of the securing pocket(s) 1308a nested within a hinge receiver port 1308 may be suitably adjusted to be complementary to the quantity, positioning and orientation, accordingly, of the securing pegs(s) disposed on the male connectors ends and port fillers adapted to appropriately nest with said hinge receiver ports 1308.

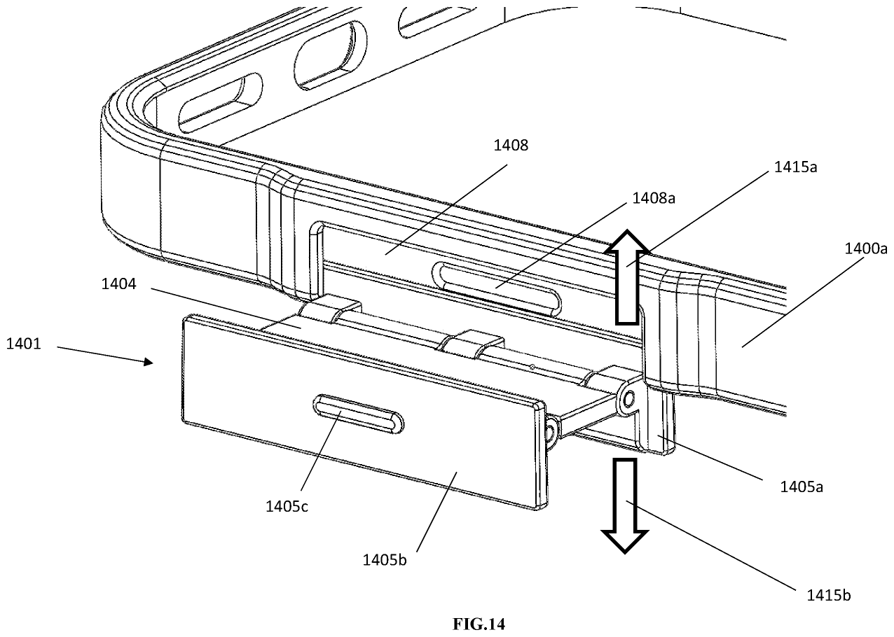

FIG. 14 illustrates the side perspective view of a connector hinge 1401 in the process of engaging with a first special-fitted smartphone case 1400a by slidably nesting within a hinge receiver port 1408, according to an aspect. As can be seen in FIG. 14, the selective engagement of the connector hinge 1401 with each special-fitted smartphone case 1400a may be achieved by sliding a portion of the connector hinge 1401, such as a corresponding male connector end 1405a, into a corresponding hinge receiver port 1408 disposed on each special-fitted smartphone case 1400a. As disclosed hereinabove, in order to facilitate a more secure connection between each individual special-fitted smartphone case 1400a and the connector hinge 1401, each male connector end 1405a and 1405b may be further comprised of at least one securing peg 1405c configured to be seated within a corresponding securing pocket 1408a upon the nesting of the male connector end 1405a within the corresponding hinge receiver port 1408. Each securing peg 1405c may be associated with and extend from a corresponding connector end body 1405e of each male connector end 1405a, 1405b, such that upon the sliding of a male connector end within the corresponding hinge receiver port 1408, each securing peg 1405c is nested within a corresponding securing pocket 1408a. This creates a secure, but reversible engagement between the corresponding special-fitted smartphone case 1400a and the connector hinge 1401. For the purposes of clarity, port fillers, such as port filler 709 of FIGS. 7A-7D, may also include securing pegs, similar to the one shown in 1405c, which can also nest within a corresponding securing pocket 1408a, such as the one shown in FIG. 14.

Similarly to the prior described port fillers, such as port filler 809 of FIG. 8B, each male connector end 1405a, 1405b may be configured to engage with a corresponding hinge receiver port 1408 via a sliding feature. As can be seen in FIG. 14, the first male connector end 1405a may be configured to be slid in a first direction 1415a into the corresponding receiver port 1408 to facilitate engagement between the connector hinge 1401 and the corresponding special-fitted smartphone case 1400a. Furthermore, the first male connector end 1405a may be selectively disengaged from the corresponding special-fitted smartphone case 1400a by sliding the first male connector end 1405a in a second direction 1415b, opposite the first direction 1415a, such that the first male connector end 1405a is slid out of the corresponding receiver port 1408.

FIG. 15 illustrates the front elevation view of a first special-fitted smartphone case 1500a and a second special-fitted smartphone case 1500b, each in a single case use configuration, with all hinge receive ports 1508-1, 1508-2, 1508-3, 1508-4 connected with corresponding port fillers 1509, according to an aspect. For clarity, the first special-fitted smartphone case 1500a may have a first hinge receiver port 1508-1 and a second receiver port 1508-2 and the second special-fitted smartphone case 1500b may have a third hinge receiver port 1508-3 and a fourth hinge receiver port 1508-4.

In alternative embodiments, a secure connection between an individual special-fitted smartphone case 1500a and either the connector hinge or port filler 1509 may be made via the usage of magnetic force and attraction. In such an example, the connector end body of the male connector ends and the port filler body of the port fillers 1509 may be embedded with a magnetic material of one polarity, while the special-fitted smartphone case material used to form the hinge receiver ports may be embedded with small magnetic material of the opposite polarity. Other mechanisms may also be utilized to further secure each special-fitted smartphone case 1500a, 1500b with either connector hinges or port fillers, as long as said mechanisms may facilitate reversible interconnection without undue force, as described herein.

FIG. 16 illustrates a front perspective view of a first special-fitted smartphone case 1600a configured for magnetic, wireless charging compatibility of its corresponding smartphone device, according to an aspect. The internal components of a special-fitted smartphone case 1600a may be configured with wireless charging and magnet, shield, coil and sensor technology 1614b, such as that compatible of Apple MagSafe®, whereby the special-fitted smartphone cases 1600a may allow the battery of its corresponding smartphone device to be charged via magnetic, wireless charging technology. The magnetic charging adapter 1614b may be incorporated into the overall case back 1614. The hinge receiver port 1608 and the corresponding securing pockets 1608a are partially depicted herein for purposes of clarity. Each special-fitted smartphone case 1600a may be comprised of a case wall 1613 engaged with a case back 1614, such that a smartphone device cavity 1616 is formed between the external facing walls 1613b of the case wall 1613, within which a corresponding smartphone device may be nested and secured.

It should be understood that each special-fitted smartphone case 1600a may be configured to maintain the functional capabilities of the corresponding smartphone device that it is configured to protect. In an embodiment, each port nested within the special-fitted smartphone case, such as case ports 1613a, may be suitably positioned on the corresponding special-fitted smartphone case 1600a to allow intended access to & utility of corresponding buttons, ports, etc. on the smartphone device. In another embodiment, a first special-fitted smartphone case 1600a may be configured to enable wireless charging capabilities for a secured first smartphone device, such as by having wireless charging magnet, shield, coil and sensor technology 1614b.

As is understood, a smartphone device may be securely nested within the smartphone device cavity 1616 in order to suitably protect said smartphone device from accidental drops, impacts, etc. A plurality of wall ports 1613a may be nested within the case wall 1613 in order to allow access to ports, slots, etc. disposed on the perimeter walls of the secured smartphone device. The case back may be comprised of (1) a case back body 1614a configured to attach to the case wall 1613, (2) a magnetic wireless charger adapter nested within the case back body 1614a, such that the smartphone device held within the special-fitted smartphone case 1600a may be suitably charged upon engagement of the special-fitted smartphone case 1600a with a suitable magnetic, wireless charging apparatus (not shown), and (3) a camera window 1614c nested within case back body 1614a. It should be understood that the magnetic, wireless charging adapter 1614b may be configured such that upon resting the special-fitted smartphone case 1600a on a suitable magnetic, wireless charging apparatus, the secured smartphone device may be charged accordingly. It should also be understood that the magnetic charging adapter 1614b may be suitably adapted to enable wireless charging for the make and model of phone it is configured to secure, as applicable and allowable by the phone itself, by directly engaging with a corresponding magnetic wireless charger device.

Furthermore, the camera window may be suitably sized and positioned to prevent the case back body 1614a from blocking external facing cameras disposed on the held smartphone device. The external facing walls 1613b of the case wall 1613 may be parallel with each other, wherein a singular hinge receiver port 1608 is nested within each corresponding external facing wall 1613b. As such, a connector hinge may be engaged with either external facing wall 1613b of a special-fitted smartphone case 1600a, thus allowing a user to select which side of the overall convertible smartphone case apparatus said special-fitted smartphone case 1600a is disposed on.

It should be understood that the hinge receiver ports 1608 on each special fitted smartphone case, including the hinge receiver ports 1608 of the first special-fitted smartphone case 1600a, may be purposefully positioned on a particular portion of the special-fitted smartphone case 1600a in order to ensure that the side buttons, ports, etc. nested within the corresponding wall ports 1613a are not obstructed by an attached connector hinge or the other special fitted smartphone case, regardless of the rotational configuration of the convertible smartphone case apparatus. In an embodiment, each hinge receiver port 1608 may be disposed on a lower portion 1613c of each corresponding external facing wall 1613b, such that an attached hinge connector and/or second special-fitted smartphone case attached to the corresponding first special-fitted smartphone case 1600a doesn't block the ports and/or buttons on the first secured smartphone device that the first special-fitted smartphone case 1600a is configured to leave accessible. The same aspect may also be true for the second special-fitted smartphone case, such as second special-fitted smartphone case 1500b of FIG. 15, wherein both of the hinge receiver ports 1508-3, 1508-4 are disposed on a lower portion of each corresponding external facing wall, to avoid blocking the buttons, ports and other relevant interactable elements disposed on the corresponding secured second smartphone device.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. As used in this application, “and/or” means that the listed items are alternatives, but the alternatives also include any combination of the listed items.

The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. The terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases.

Throughout this description, the aspects, embodiments or examples shown should be considered as exemplars, rather than limitations on the apparatus or procedures disclosed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples.

What is claimed is:

1. A convertible smartphone case apparatus comprising:
a connector hinge having:
an interconnection plate;
a first male connector end comprising:
a connector end body;
a securing peg attached to the corresponding connector end body; and
a second male connector end comprising:
a connector end body;
a securing peg attached to the corresponding connector end body;
wherein the first male connector end and the second male connector end are configured to pivotally engage with the interconnection plate;
a first smartphone case having two hinge receiver ports and a securing pocket nested within each corresponding hinge receiver port, wherein the first male connector end is configured to be selectively nested within a corresponding hinge receiver port of the first smartphone case, such that the securing peg of the first male connector end is nested within a corresponding securing pocket of the first smartphone case and the first smartphone case is configured to be selectively pivoted about the interconnection plate; and
a second smartphone case having two hinge receiver ports and a securing pocket nested within each corresponding hinge receiver port, wherein the second male connector end is configured to be selectively nested within a corresponding hinge receiver port of the second smartphone case, such that the securing peg of the second male connector end is nested within a corresponding securing pocket of the second smartphone case and the second smartphone case is configured to be selectively pivoted about the interconnection plate;
wherein the first smartphone case is configured to secure and protect a first smartphone device and the second smartphone case is configured to secure and protect a second smartphone device.

2. The convertible smartphone case apparatus of claim 1, wherein the first male connector end is further comprised of an additional securing peg attached to the corresponding connector end body, the second male connector end is further comprised of an additional securing peg attached to the corresponding connector end body, the first smartphone case is further comprised of an additional securing pocket nested within the corresponding hinge receiver port and the second smartphone case is further comprised of an additional securing pocket nested within the corresponding hinge receiver port, such that each male connector end has two securing pegs and each hinge receiver port has two securing pockets, wherein each securing peg of the first male connector end is configured to engage with a corresponding securing pocket of the first smartphone case and each securing peg of the second male connector end is configured to engage with a corresponding securing pocket of the second smartphone case.

3. The convertible smartphone case apparatus of claim 1, wherein the first smartphone case is further comprised of a case wall having a pair of external facing side walls and a case back attached to the case wall, wherein a corresponding hinge receiver port is nested within each external facing side wall of the pair of external facing side walls, wherein the selective engagement of the connector hinge with each smartphone case is achieved by sliding a corresponding male connector end into a corresponding hinge receiver port disposed on each smartphone case.

4. The first smartphone case of claim 3, further comprising a magnetic, wireless charging adapter nested within the case back, wherein the magnetic, wireless charging adapter is configured to allow the first smartphone case to be engaged with a magnetic, wireless charging apparatus to charge the first smartphone device.

5. The convertible smartphone case apparatus of claim 1, further comprising a port filler configured to be selectively engaged with a corresponding hinge receiver port, the port filler comprising:
A port filler body; and
A securing peg attached to the port filler body, wherein the securing peg of the port filler is configured to be nested within the securing pocket of the corresponding hinge receiver port.

6. The port filler of claim 5, further comprising a rib feature attached to the port filler body, wherein the rib feature is configured to be manipulated to selectively remove the port filler from the corresponding hinge receiver port.

7. The convertible smartphone case apparatus of claim 1, wherein the first smartphone case and the second smartphone case are each configured to be selectively pivoted about the interconnection plate such that a screen of the first smartphone device and a screen of the second smartphone device are facing toward each other and concealed within the convertible smartphone case apparatus.

8. The convertible smartphone case apparatus of claim 1, wherein the first smartphone case and the second smartphone case are each configured to be selectively pivoted about the interconnection plate such that a screen of the first smartphone device faces away from a screen of the second smartphone device.

9. The convertible smartphone case apparatus of claim 1, wherein the interconnection plate is made of a rigid plastic, wherein the interconnection plate is configured to resist deformation, such that a first rotational axis of the first smartphone case is configured to remain parallel with a second rotational axis of the second smartphone case, while the first and second smartphone cases are both engaged with the connector hinge.

10. A convertible smartphone case apparatus comprising:
a connector hinge having:
an interconnection plate;
a first male connector end pivotally engaged with the interconnection plate; and
a second male connector end pivotally engaged with the interconnection plate;
a first smartphone case having a hinge receiver port, wherein the first male connector end is configured to be selectively nested within the hinge receiver port of the first smartphone case, such that the first smartphone case is configured to be selectively pivoted about the interconnection plate; and
a second smartphone case having a hinge receiver port, wherein the second male connector end is configured to be selectively nested within the hinge receiver port of the second smartphone case, such that the second smartphone case is configured to be selectively pivoted about the interconnection plate;
wherein first smartphone case is configured to secure and protect a first smartphone device and the second smartphone case is configured to secure and protect a second smartphone device.

11. The convertible smartphone case apparatus of claim 10, further comprising a securing peg attached to the first male connector end and a securing peg attached to the second male connector end, wherein the securing peg attached to the first male connector end is configured to engage with a securing pocket nested within the hinge receiver port of the first smartphone case and the securing peg attached the second male connector end is configured to engage with a securing pocket nested within the hinge receiver port of the second smartphone case, wherein the selective engagement of the connector hinge with each smartphone case is achieved by sliding a corresponding male connector end into a corresponding hinge receiver port disposed on each smartphone case.

12. The convertible smartphone case apparatus of claim 10, wherein the first smartphone case and the second smartphone case are configured to be selectively pivoted about the interconnection hinge such that a screen of the first smartphone device and a screen of the second smartphone device are facing toward each other and concealed within the convertible smartphone case apparatus.

13. The convertible smartphone case apparatus of claim 10, further comprising a port filler configured to engage with a corresponding hinge receiver port, wherein the port filler is configured to cover and protect the corresponding hinge receiver port.

14. The convertible smartphone case apparatus of claim 10, wherein the first and second smartphone cases are each configured to secure and protect a corresponding smartphone device, regardless of engagement with the connector hinge.

15. A convertible smartphone case apparatus comprising:
a connector hinge;
a first smartphone case configured to be selectively engaged with the connector hinge, wherein the first smartphone case is configured to secure and protect a first smartphone device;
a second smartphone case configured to be selectively engaged with the connector hinge, wherein the second smartphone case each configured to secure and protect a second smartphone device;
wherein the first smartphone case and the second smartphone case are each configured to be selectively pivoted about the connector hinge.

16. The convertible smartphone case apparatus of claim 15, wherein the first and second smartphone cases are each comprised of a case wall having a pair of external facing side walls, and a corresponding hinge receiver port nested within each external facing side wall of the pair of external facing side walls, wherein each hinge receiver port of the first and second smartphone cases is configured to selectively engage with the connector hinge, wherein the selective engagement of the connector hinge with each smartphone case is achieved by sliding a portion of the connector hinge into a corresponding hinge receiver port disposed on each smartphone case.

17. The convertible smartphone case apparatus of claim 16, further comprising a securing peg extending from the connector hinge that is configured to be engaged with a securing pocket nested within a corresponding hinge receiver port of the first smartphone case and a securing peg extending from the connector hinge that is configured to be engaged with a securing pocket nested within a corresponding hinge receiver port of the second smartphone case.

18. The convertible smartphone case apparatus of claim 16, further comprising a port filler configured to engage with a corresponding hinge receiver port that is not engaged with a connector hinge.

19. The convertible smartphone case apparatus of claim 15, further comprising a magnetic, wireless charging adapter nested within the first smartphone case, wherein the magnetic, wireless charging adapter is configured to enable magnetic, wireless charging of the first smartphone device by engaging the first smartphone case with a magnetic, wireless charging apparatus.

20. The convertible smartphone case apparatus of claim 15, wherein the first smartphone case and the second smartphone case are each configured to be selectively pivoted about the connector hinge such that a screen of the first smartphone device and a screen of the second smartphone device are facing toward each other and concealed within the convertible smartphone case apparatus.
